(19) United States
(12) Patent Application Publication
(10) Pub. No.: US 2025/0056390 A1
(43) Pub. Date: Feb. 13, 2025

(54) METHOD FOR CONTROLLING SERVICE QUALITY IN WIRELESS COMMUNICATION SYSTEM

(71) Applicant: SAMSUNG ELECTRONICS CO., LTD., Suwon-si (KR)

(72) Inventors: Hyesung KIM, Suwon-si (KR); Sangjun MOON, Suwon-si (KR); Dongeun SUH, Suwon-si (KR); Hoyeon LEE, Suwon-si (KR)

(21) Appl. No.: 18/799,734

(22) Filed: Aug. 9, 2024

(30) Foreign Application Priority Data
Aug. 10, 2023 (KR) 10-2023-0105165

(51) Int. Cl. H04W 48/16; H04W 12/06; H04W 24/10

(52) U.S. Cl. CPC H04W 48/16; H04W 24/10; H04W 12/06

(57) ABSTRACT

The disclosure relates to a 5G or 6G communication system for supporting a higher data transmission rate. A method for operating a sensing network function in a communication system supporting integrated sensing and communication (ISAC), according to an embodiment, may comprise receiving a first request message for a sensing service, transmitting a second request message for requesting sensing policy data based on the first request message, and receiving a response message corresponding to the second request message and including sensing service quality information.

### CROSS-REFERENCE TO RELATED APPLICATION

This application is based on and claims priority under 35 U.S.C. § 119 to Korean Patent Application No. 10-2023-0105165, which was filed in the Korean Intellectual Property Office on Aug. 10, 2023, the entire disclosure of which is incorporated herein by reference.

### BACKGROUND

### 1. Field

The disclosure provides a method for controlling the quality of an integrated sensing and communications or joint communications and sensing service among the services provided in a wireless communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

When providing an integrated sensing/communication service through a wireless communication system, a method for determining and configuring and applying corresponding service quality is required. A quality control method and device supported in a system providing only communication services is designed for the purpose of guaranteeing traffic transmission/reception quality for a pair of transmission/reception devices or a specific session. In the integrated sensing/communication service, the purpose of quality control on a specific session is not a priority, and communication quality control on the pair of transmission/reception devices is not directly related to sensing service quality.

The disclosure provides various methods for controlling the quality of an integrated sensing and communications or joint communications and sensing) service among the services provided in a wireless communication system.

The disclosure provides major parameters that may represent integrated sensing/communication service quality.

The disclosure provides a method for generating, authenticating, and configuring integrated sensing/communication service quality information based on an integrated sensing/communication service request.

A method for operating a sensing network function in a communication system supporting integrated sensing and communication (ISAC), according to an embodiment, may comprise receiving a first request message for a sensing service, transmitting a second request message for requesting sensing policy data based on the first request message, and receiving a response message corresponding to the second request message and including sensing service quality information.

A network entity in which a sensing network function is implemented in a communication system supporting integrated sensing and communication (ISAC), according to an embodiment, comprises a transceiver and a controller. The controller may receive a first request message for a sensing service, control to transmit a second request message for requesting sensing policy data based on the first request message, and receive a response message corresponding to the second request message and including sensing service quality information.

Embodiments of the disclosure may guarantee the quality of an integrated sensing/communication service provided by a wireless communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 illustrates a 5G system structure supporting an integrated sensing and communications service according to an embodiment of the present disclosure;

FIGS. 2A and 2B illustrate an ISAC service quality determination and configuration method (based on a sensing network function) according to an embodiment of the present disclosure;

FIGS. 3A and 3B illustrate an ISAC service quality determination and configuration method based on PCF interworking with a sensing network function according to an embodiment of the present disclosure;

FIG. 4 illustrates a UE according to an embodiment of the present disclosure; and

FIG. 5 illustrates a network entity according to an embodiment of the present disclosure.

### DETAILED DESCRIPTION

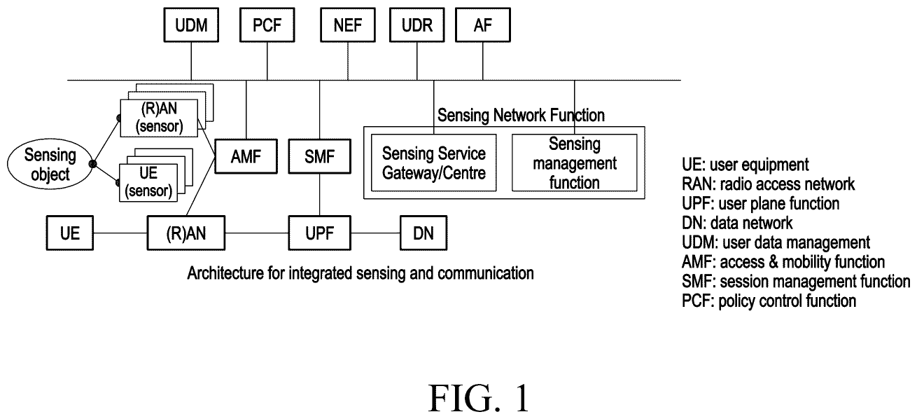

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operational principle of the disclosure is described below with reference to the accompanying drawings. The terms described below are ones defined considering functions in the disclosure. Since the terms may be varied according to the user's or operator's intent or custom, their definitions should be determined according to the contents throughout the disclosure.

The terms referring to network entities or network functions and objects of a wireless communication system as used herein, the terms referring to messages, and the term referring to identification information are provided as an example for ease of description. Thus, the disclosure is not limited by the terms, and such terms may be replaced with other terms denoting objects with equivalent technical concept.

Although terms and names as defined in the 5G system standard are used herein for ease of description, embodiments of the disclosure are not limited thereto or thereby, and the same may apply likewise to wireless communication systems conforming to other standards or next-generation standards.

FIG. 1 illustrates a 5G system structure supporting an integrated sensing and communications service, (e.g., hereinafter referred to as an ISAC service for convenience of description) according to an embodiment of the present disclosure.

A 5G system structure supporting an ISAC service may include various network functions (NFs), some of which are illustrated in FIG. 1, such as an access and mobility management function (AMF), a session management function (SMF), a policy control function (PCF), unified data management (UDM), unified data repository (UDR), a data network (DN), or a local part of DN capable of local access to the data network, a user plane function (UPF), a (radio) access network ((R)AN), and a user equipment (UE).

Each NF supports the following functions.
An AMF provides functions for per-UE access and mobility management and may connect basically to one AMF per UE.
A DN means, e.g., an operator service, Internet access, or a third party service. The DN transmits a downlink protocol data unit (PDU) to the UPF or receives a PDU transmitted from UPF. Local part of DN means a data network having a short data transmission path as it may local-access a portion of the DN. It may be used to denote a DN where an edge application server supporting an edge computing service is deployed.
A PCF receives information about a packet flow from an application server and provides the function of determining the policy such as mobility management or session management. Specifically, the PCF supports functions such as support of a singlized policy framework for controlling network operations, providing a policy rule to allow CP function(s) (e.g., AMF or SMF) to execute a policy rule, and implementation of a front end for accessing subscription information related to policy decision in the unified data repository (UDR).
An SMF provides a session management function and, if a UE has multiple sessions, this may be managed per session by a different SMF.
UDM stores, e.g., user's subscription data, policy data.
A UPF transfers a downlink PDU received from a DN to a UE via (R)AN and transfers an uplink PDU received from a UE to a DN via (R)AN. An uplink classifier (ULCL) refers to a UPF having a function of classifying and transmitting uplinks. A local UPF (L-UPF) serves as a PDU session anchor of a session transmitted to the local part of DN.
A sensing network function is a network function to support ISAC service. The sensing network function may receive an ISAC service request and perform at least one of authentication for the corresponding request, ISAC service quality control policy generation and configuration, discovery and selection of a network device and a UE performing a sensing operation, compiling of sensing results, and processing. The above-described operations may be configured or implemented as a sensing service gateway/centre and a sensing management function which are two network functions logically separated. For example, when configured/implemented as logically separated network functions, the sensing service gateway/centre may be centrally deployed to receive an ISAC service request and perform an authentication operation, may perform operations such as ISAC service quality control policy generation, and the sensing management function may be distributively and locally deployed to perform discovery and selection of the network device and UE, compiling of sensing results and processing to perform an actual sensing operation. In the disclosure, the method for configuring a sensing network function is not limited, and an embodiment in which they are integrated and configured and operated as a single one and an embodiment in which they are separated and operated both are included in the scope of the disclosure.
UEs may be divided into a UE actually requesting an ISAC service and a UE serving as a sensor to detect a sensing target object (or simply sensing object) to provide an ISAC service in the wireless communication system.
The base station of the (R)AN constituting the radio access network may perform the operation of detecting the sensing object as a sensor, as well as transmitting/receiving signals for communication.

The integrated sensing/communication service quality information may be used in the wireless communication system and an external ISAC service requesting device to control the quality of the ISAC service according to an embodiment. For the purpose of describing the following embodiments. ISAC service quality-related information is denoted as sensing service quality (SSQ) information. The sensing service quality information may include at least one of the pieces of information described in Table 1 below.

TABLE 1
ISAC service quality-related information (sensing service quality (SSQ) information)

Missed detection probability: means the probability that the sensing object is
determined to be absent and is thus not detected when the sensing object is present in a specific
space.
False alarm probability: means the probability that the sensing object is determined to
be present when the sensing object is absent in a specific space, causing false detection.
Sensing resolution (range resolution, velocity resolution), e.g., to distinguish the
different sensing target space: means the temporal, spatial required resolutions when performing
sensing.
Sensing target area: means the target area where sensing may be performed and may
be constituted of indoor/outdoor information and position information. For example, it may be
represented in the form of a polygon or a single closed loop constituted of specific coordinates
or may have a value, such as cell ID, tracking area ID, or PLMN ID used in the wireless
communication system. Information indicating whether indoors or outdoors, such as such
information, may be provided.
Accuracy in sensing specific domain: means accuracy information specified for a
sensing service having a specific purpose. For example, for an ISAC service that measures and
provides the population density or target object density in a specific space, it may be represented
as a value indicating density accuracy (percentage for the number of objects per square/cubic
metre), and may include a score and percentage value indicating accuracy and unit information
(number of objects per square/cubic metre) that may indicate what information the
corresponding value is/whether it is an actually measured value.
Sensing quality container (for customized SSQ info): means a container or magnet for
providing sensing service quality information not standardized according to agreement with the
operator providing the mobile network system providing the ISAC service and a 3rd party
operator or organization requiring a sensing service. For example, it may be represented as
unstructured data for SSQ, defined based on SLA between operator and client, e.g., Humidity
level.
Assurance type: means the scheme or type or class of guaranteeing sensing service
quality requested or set. For example, it means that given sensing service quality may be
essentially guaranteed if a guaranteed sensing service class value is allocated. If the given quality
may not be guaranteed, the sensing service request may be rejected. Or, if a non-guaranteed
sensing service class (or best effort sensing service class) value is allocated, when the given
sensing service quality may not be guaranteed, it may be determined to provide the sensing
service in a best effort manner. If assurance type includes non-guaranteed sensing service class,
SSQ information (e.g., separate SSQ information defined as alternative SSQ) may be
additionally provided, and may be used as ISAC service quality information that may be, or may
be applied, when the SSQ requested by the ISAC service requester in the system may not be
met.
Response time (or max sensing service latency): means the latency time until the
resultant value according to the ISAC service request is provided.
Refresh rate: means a time (e.g., time period value) or frequency (Hz) indicating
whether the ISAC service resultant value needs to be updated periodically.
Accuracy of location/velocity estimate by sensing: means accuracy information about
the location and velocity of the sensing object when the sensing resultant value which is the
ISAC service result and the location or velocity of the sensing object are measured and provided
together.
Confidence level: means the reliability level of the sensing resultant value provided as
the ISAC service result.
SSQ Index/Identifier: means an identifier or index value used as a reference meaning
a specific SSQ quality. When network devices that may serve as sensing network functions or
sensors are given the corresponding identifier or index value, SSQ quality element information
may be specified, and a sensing operation for meeting the quality may be performed.

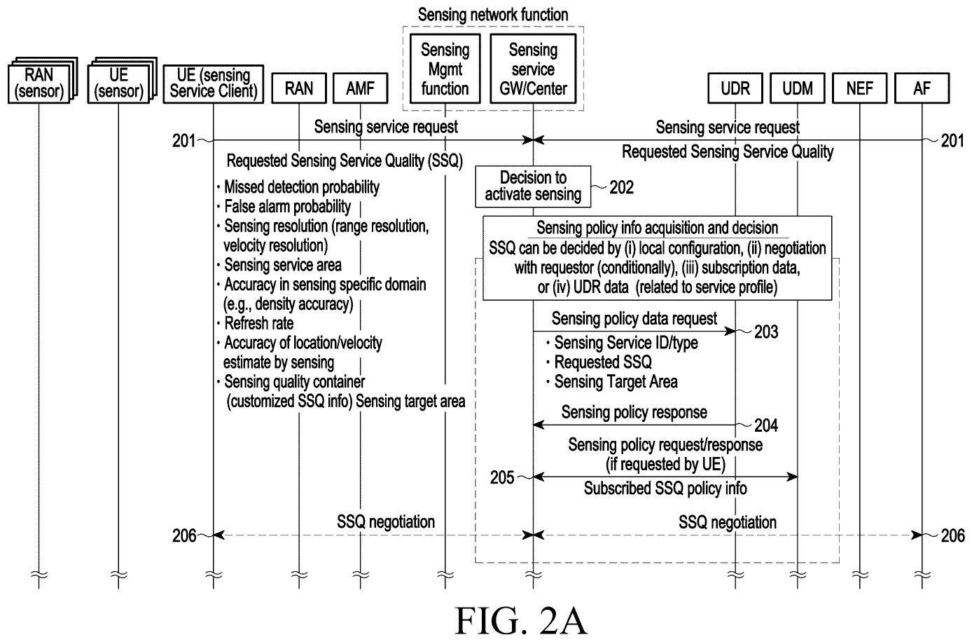

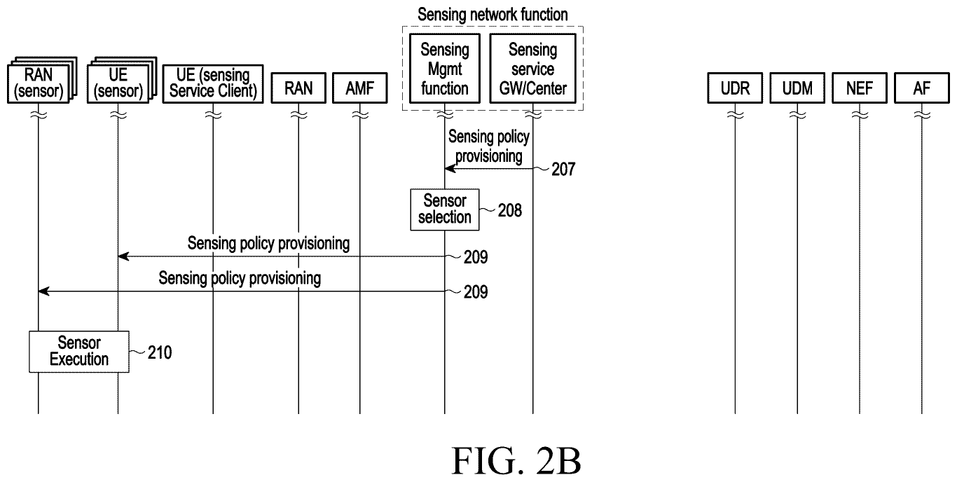

FIGS. 2A and 2B illustrate an ISAC service quality determination and configuration method (based on a sensing network function) according to an embodiment of the present disclosure.

Referring to FIG. 2A, in step 201, a UE, an AF, or a separate ISAC client may transmit an ISAC service request to a sensing network function (e.g., a sensing service GW/Centre, hereinafter “SSGC”). The request message transmitted by the AF may be transmitted to the sensing network function directly or through the NEF. The message transmitted by the UE may be transmitted to the sensing network function through the RAN or the UPF, or may be transmitted to the sensing network function through the RAN or the AMF. The message transmitted by the separate ISAC client may be transmitted to the sensing network function directly, through the NEF, through the RAN/UPF, or through the RAN/AMF, depending on the placement position of the client. The ISAC service request message may include information such as the identifier (UE identifier, AF ID, or ISAC client identifier) of the requesting object, and ISAC service type, ISAC service identifier, ISAC service target area or such information, and sensing service quality (SSQ) information indicating the required ISAC service quality information.

As an embodiment, the sensing service quality information SSQ may include at least one of the information described in Table 1. Alternatively, the sensing service quality information SSQ may include only a sensing service quality information index or an identifier (SSQ index/identifier) value. When an SSQ index/identifier is given, the sensing network function may specify SSQ element information (at least one piece of quality information listed in Table 1) corresponding thereto.

As another embodiment, SSQ information may be provided for one ISAC service type or ISAC service identifier. In this case, the remaining SSQ information except for one may mean alternative SSQ. Alternative SSQ may mean an SSQ to be instead applied sequentially when the highest request SSQ may not be met in the ISAC service providing system.

In step 202, the sensing network function (e.g., sensing service GW/Centre, hereinafter “SSGC”) may perform authentication on the sensing service requester. Such authentication may be performed using the information received in step 1 and through interworking with another network function (e.g., UDM or NEF).

In step 203, the sensing network function may perform an operation for determining an SSQ to be actually applied after authentication for the sensing service request is successfully performed. The sensing network function may transmit sensing policy data or a sensing service profile request message to the UDR. The request message may include the ISAC service requester identifier (UE identifier or AF ID), the ISAC service identifier, the ISAC service type, and requested SSQ information (e.g., including at least one of the attribute name and requested value of the information received in step 1 among the pieces of information in Table 1 or the sensing service quality information index).

In step 204, the UDR may select sensing policy data or sensing service profile information corresponding to the information received from the sensing network function and provide the same to the sensing network function. The sensing policy data or sensing service profile information may include SSQ information that the system may provide to the service requester of step 201. The SSQ information provided by the UDR may include at least one of the information described in Table 1, and each information means the ISAC service quality previously set from the OAM or an external application function.

In step 205, when the sensing network function receives the ISAC service request from the UE in step 201, the sensing network function may request and obtain sensing policy data or sensing service profile information for the corresponding UE from the UDM. Subscribed SSQ information may be included in the information provided by the UDM. Subscribed SSQ information may include at least one of the information described in Table 1, and each information means the ISAC service quality that may be provided according to subscriber information. The operation of step 205 may be performed immediately after step 201.

In step 206, the sensing network function may determine the SSQ to be actually applied considering the requested SSQ received in step 201, the SSQ obtained from the UDR, and the subscribed SSQ information obtained from the UDM.

According to an embodiment, when the SSQ assurance type information received in step 201 includes a guaranteed sensing service class, if the applied SSQ information determined by the sensing network function is lower than the requested SSQ (i.e., if the requested SSQ may not be guaranteed), the sensing network function may provide information indicating that the requested SSQ may not be guaranteed and what specific SSQ quality may not be guaranteed to the service requesting device (UE, AF, or ISAC service client) of step 201.

According to another embodiment, when the SSQ assurance type information received in step 201 includes a non-guaranteed sensing service class (or best effort class), if the sensing network function determines to apply an SSQ lower than the requested SSQ in step 201, the sensing network function may provide the determined applied SSQ information to the requesting device (UE, AF, or ISAC service client) of step 201. The sensing network function may receive an acknowledgement for the applied SSQ from the requesting device of step 201.

In step 207, the sensing network function may provide the applied SSQ determined in the previous step to the network function directly participating in actually performing sensing. According to an embodiment, the applied SSQ may be transmitted while providing sensing service policy information to the sensing management function capable of configuring the sensing network function.

In step 208, the sensing management function may select a network device (e.g., a base station supporting sensing) or a UE that serves as a sensor to actually perform sensing. A plurality of UEs or network devices may be selected.

In step 209, the sensing management function may transmit a sensing service policy including applied SSQ information to the selected network device serving as a sensor. The sensing service policy may include information such as application SSQ information, ISAC service identifier, ISAC service type, application space range, application time range, etc.

In step 210, the UE or the network device serving as the sensor may perform sensing operation-related configuration (wireless resource allocation, non-3GPP sensing device activation, etc.) and the sensing operation based on the applied SSQ information included in the sensing service policy.

In performing at least one operation described above, the sensing network function may receive the ISAC service request information including the ISAC service type or the ISAC service identifier without receiving the element information constituting the SSQ of Table 1. The sensing network function may determine the applied SSQ according to the local configuration on its own. Alternatively, as another example, when performing operation 204, the sensing network function may obtain SSQ information corresponding to the ISAC service type or the ISAC service identifier from the UDR.

As described above, the sensing network function may receive the SSQ information from the ISAC service requester, or may generate the applied SSQ information while performing the operations of steps 203 to 205 and provide the same to a device serving as a sensor. When the applied SSQ information are generated, SSQ information other than the SSQ indicating the highest quality may be used as alternative SSQ information.

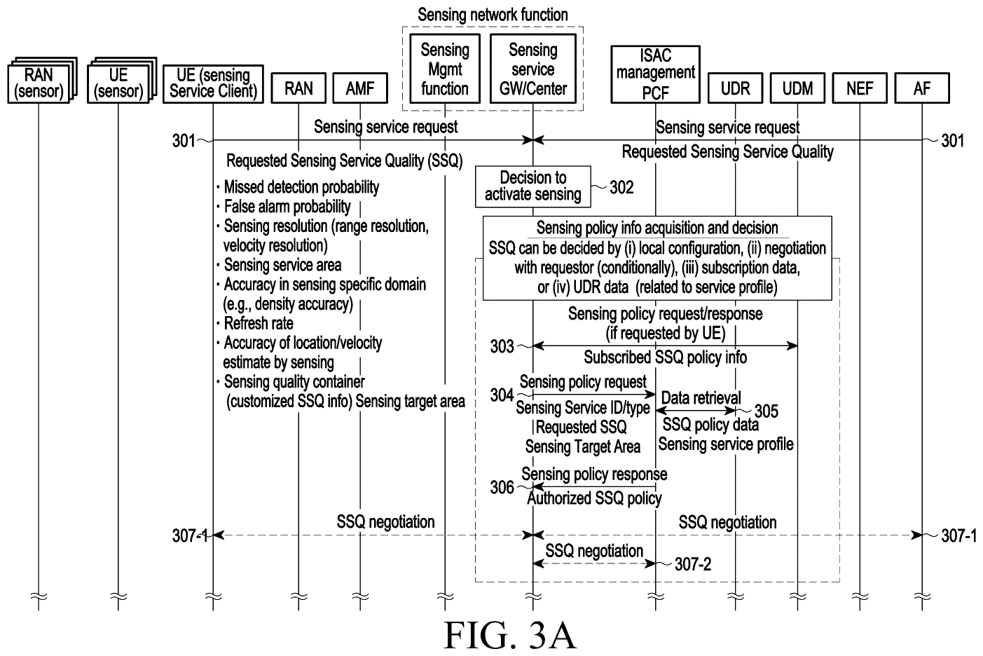

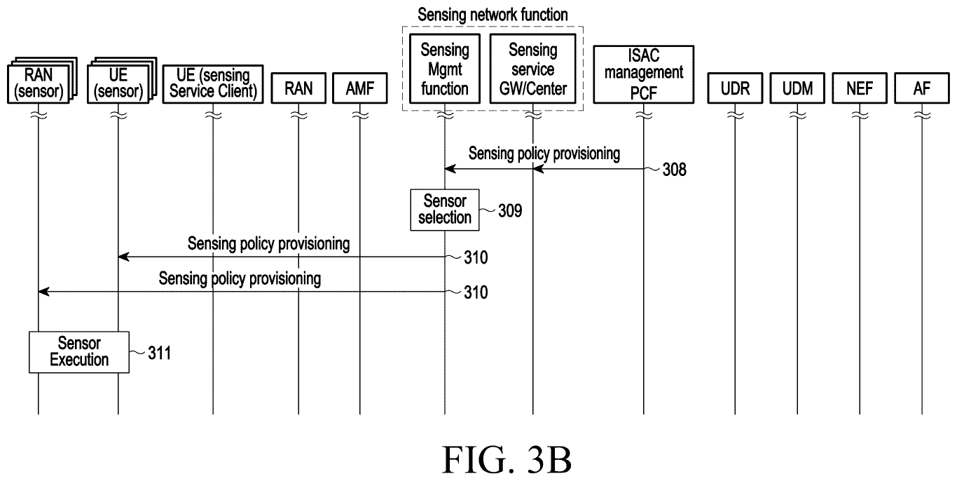

FIGS. 3A and 3B illustrate an ISAC service quality determination and configuration method (based on PCF interworking with a sensing network function) according to an embodiment of the present disclosure.

Referring to FIG. 3A, in step 301, the UE, the AF, or a separate ISAC client may provide an ISAC service request to the sensing network function (e.g., the sensing service GW/Centre, hereinafter “SSGC”) as in step 201 of FIG. 2. The ISAC service request message may include information such as the identifier (UE identifier, AF ID, or ISAC client identifier) of the requesting object, and ISAC service type, ISAC service identifier, ISAC service target area or such information, and sensing service quality (SSQ) information indicating the required ISAC service quality information. As an embodiment, the sensing service quality information SSQ may include at least one of the information described in Table 1. Alternatively, the sensing service quality information SSQ may include only a sensing service quality information index or an identifier (SSQ index/identifier) value. When an SSQ index/identifier is given, the sensing network function may specify SSQ element information (at least one piece of quality information listed in Table 1) corresponding thereto.

As another embodiment, SSQ information may be provided for one ISAC service type or ISAC service identifier. In this case, the remaining SSQ information except for one may mean alternative SSQ. Alternative SSQ may mean an SSQ to be instead applied sequentially when the highest request SSQ may not be met in the ISAC service providing system.

In step 302, the sensing network function (e.g., sensing service GW/Centre, hereinafter “SSGC”) may perform authentication on the sensing service requester. Such authentication may be performed using the information received in step 301 and through interworking with another network function (e.g., UDM or NEF).

In step 303, when the sensing network function receives the ISAC service request from the UE in step 1, the sensing network function may request and obtain sensing policy data or sensing service profile information for the corresponding UE from the UDM. Subscribed SSQ information may be included in the information provided by the UDM. Subscribed SSQ information may include at least one of the information described in Table 1, and each information means the ISAC service quality that may be provided according to subscriber information.

In step 304, the sensing network function may perform an operation for determining an SSQ to be actually applied after authentication for the sensing service request is successfully performed. The sensing network function may transmit sensing policy data or a sensing service profile request message (e.g., the ISAC policy request) to the PCF. The request message may include the ISAC service requester identifier (UE identifier or AF ID), the ISAC service identifier, the ISAC service type, and requested SSQ information (e.g., including at least one of the attribute name and requested value of the information received in step 1 among the pieces of information in Table 1 or the sensing service quality information index). If the sensing network function has obtained the subscribed SSQ information from the UDM in the previous step, the subscribed SSQ information may also be provided to the PCF. The PCF that receives and processes the ssq-related request of the sensing network function may be expressed as a sensing management PCF or an ISAC management PCF (hereinafter, “IM PCF”).

In step 305, the IM PCF may provide information received from the sensing network function to the UDR, and may obtain sensing policy data or sensing service profile information in response thereto. For example, the UDR may select sensing policy data or sensing service profile information corresponding to the ISAC service type or ISAC service identifier, the ISAC requester identifier (UE identifier or AF identifier or ISAC client identifier), which is information received from the IM PCF, and provide the same to the IM PCF. The sensing policy data or sensing service profile information may include SSQ information that the system may provide to the service requester of step 301. The SSQ information provided by the UDR may include at least one of the information described in Table 1, and each information means the ISAC service quality previously set from the OAM or an external application function.

In step 306, the IM PCF may determine an SSQ to be actually applied considering at least one of the requested SSQ received in step 1, subscribed SSQ information, or SSQ obtained from the UDR and may provide the same to the sensing network function.

According to an embodiment, when the SSQ assurance type information received in step 301 includes a guaranteed sensing service class, if the applied SSQ information determined by the IM PCF is lower than the requested SSQ (i.e., if the requested SSQ may not be guaranteed), the IM PCF may provide information indicating that the requested SSQ may not be guaranteed and what specific SSQ quality may not be guaranteed to the sensing network function.

In step 307, the information indicating that the requested SSQ may not be guaranteed and the information about what specific SSQ quality may not be guaranteed may be provided to the service requesting device (UE, AF, or ISAC service client) of step 1 through the sensing network function (307-1). According to another embodiment, when the SSQ assurance type information provided in step 1 includes a non-guaranteed sensing service class (or best effort class) and is provided to the IM PCF, if the IM PCF determines to apply an SSQ lower than the requested SSQ, the sensing network function may receive the determined applied SSQ information from the IM PCF and subsequently provide the same to the requesting device (UE, AF, or ISAC service client) of step 1. The sensing network function may receive an acknowledgement for the applied SSQ from the requesting device in step 301, and the corresponding acknowledgement may be provided from the sensing network function to the IM PCF (307-2).

In step 308, the IM PCF may determine information about the finally applied SSQ and provide the same to the sensing network function. The sensing network function may provide the applied SSQ determined in the previous step to the network function (e.g., the sensing management function) directly participating in actually performing sensing. According to an embodiment, the applied SSQ may be transmitted while providing sensing service policy information to the sensing management function capable of configuring the sensing network function.

In step 309, the sensing management function may select a network device (e.g., a base station supporting sensing) or a UE that serves as a sensor to actually perform sensing. A plurality of UEs or network devices may be selected.

In step 310, the sensing management function may transmit a sensing service policy including applied SSQ information to the selected network device serving as a sensor. The sensing service policy may include information such as application SSQ information, ISAC service identifier, ISAC service type, application space range, application time range, etc.

In step 311, the UE or the network device serving as the sensor may perform sensing operation-related configuration (wireless resource allocation, non-3GPP sensing device activation, etc.) and the sensing operation based on the applied SSQ information included in the sensing service policy.

In the description of FIGS. 2A to 3B, the sensing management function and sensing service GW/centre that constitute the sensing network function may be implemented separately as independent network function instances, and may perform the described operations as individual network function instances. Alternatively, the sensing management function and sensing service GW/centre may be implemented as functionalities independent from each other and be included in an existing network function instance. For example, the sensing management function may be implemented as some functionality of the location management function, and the sensing service GW/centre may be implemented as some functionality of the gateway mobile location centre. As such, when implemented as some functionality of the existing network function, the operations and provided service of the sensing management function and the sensing service GW/centre may be defined as additional operations and additional service instances provided by the existing network function.

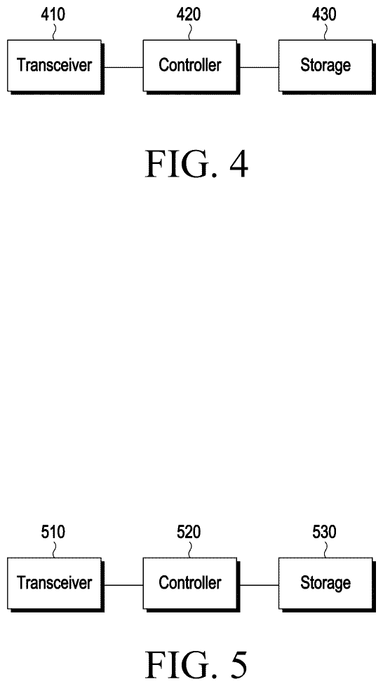

FIG. 4 illustrates a UE according to an embodiment of the present disclosure.

In the embodiment of FIG. 4, a UE may be the UE or UE device shown in each of FIGS. 1 to 3B.

Referring to FIG. 4, the UE may include a transceiver 410, a controller 420, and a storage 430. In the disclosure, the controller may be defined as a circuit or application-specific integrated circuit or at least one processor.

The transceiver 410 may transmit and receive signals to/from a base station or a network entity. The transceiver 410 may transmit/receive data to/from the base station or the network entity using, e.g., wireless communication.

The controller 420 may control the overall operation of the UE according to an embodiment. For example, the controller 420 may control the signal flow between the blocks to perform the operations described in connection with FIGS. 1 to 3B.

The storage 430 may store at least one of information transmitted/received via the transceiver 410 and information generated via the controller 420. For example, the storage 430 may store information and data necessary for the method described above with reference to FIGS. 1 to 3B.

FIG. 5 illustrates a network entity according to an embodiment of the present disclosure.

In the embodiment of FIG. 5, the network entity may be the base station or the network entity device shown in each of FIGS. 1 to 3B. According to an embodiment, the network entity may be implemented as any one of a RAN, an AMF, a sensing network function, a UDR, a UDM, an NEF, and an AF as shown in FIGS. 1 to 3B.

Referring to FIG. 5, the network entity may include a transceiver 510, a controller 520, and a storage 530. In the disclosure, the controller may be defined as a circuit or application-specific integrated circuit or at least one processor.

The transceiver 510 may transmit and receive signals to/from the UE, the base station, or another network entity. The transceiver 510 may transmit/receive data to/from the UE, base station or the other network entity using, e.g., wireless communication.

The controller 520 may control the overall operation of the network entity according to an embodiment. For example, the controller 520 may control the signal flow between the blocks to perform the operations described in connection with FIGS. 1 to 3B.

The storage 530 may store at least one of information transmitted/received via the transceiver 510 and information generated via the controller 520. For example, the storage 530 may store information and data necessary for the method described above with reference to FIGS. 1 to 3B.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a network entity for operating a sensing network function in a communication system supporting integrated sensing and communication (ISAC), the method comprising:
receiving, from a user equipment (UE) or an application function (AF), a first request message for a sensing service;
transmitting, to a unified data repository (UDR), a second request message for requesting sensing policy data based on the first request message; and
receiving, from the UDR, a response message in response to transmitting the second request message, wherein the response message includes sensing service quality (SSQ) information.

2. The method of claim 1, wherein the first request message includes at least one of a UE identifier, an AF identifier, ISAC service type, ISAC service identifier, ISAC service target area, and SSQ information indicating required ISAC service quality information.

3. The method of claim 1, wherein the second request message includes at least one of identifier information for the sensing service, requested sensing service quality information, or information regarding a sensing target area.

4. The method of claim 1, further comprising:
performing a negotiation operation for sensing service quality information after receiving the response message.

5. The method of claim 1, further comprising:
transmitting, to a unified data management (UDM), a message for requesting sensing policy data or sensing service profile information for the UE; and
receiving, from the UDM, subscribed sensing service quality (SSQ) information.

6. The method of claim 1, further comprising:
transmitting, to the UE, a sensing service policy including at least one of information for application SSQ information, ISAC service identifier, ISAC service type, application space range, or application time range.

7. The method of claim 1, further comprising:
performing authentication on sensing service requester through interworking with a unified data management (UDM) or a network exposure function (NEF).

8. A network entity for operating a sensing network function in a communication system supporting integrated sensing and communication (ISAC), the network entity comprising:
a transceiver; and
a controller operably coupled to the transceiver, the controller configured to:
receive, from a user equipment (UE) or an application function (AF), a first request message for a sensing service,
transmit, to a unified data repository (UDR), a second request message for requesting sensing policy data based on the first request message, and
receive, from the UDR, a response message in response to transmitting the second request message, wherein the response message includes sensing service quality (SSQ) information.

9. The network entity of claim 8, wherein the first request message includes at least one of a UE identifier, an AF identifier, ISAC service type, ISAC service identifier, ISAC service target area, and SSQ information indicating required ISAC service quality information.

10. The network entity of claim 8, wherein the second request message includes at least one of identifier information for the sensing service, requested sensing service quality information, or information regarding a sensing target area.

11. The network entity of claim 8, wherein the controller is further configured to:
perform a negotiation operation for sensing service quality information after receiving the response message.

12. The network entity of claim 8, wherein the controller is further configured to:
transmit, to a unified data management (UDM), a message for requesting sensing policy data or sensing service profile information for the UE, and
receive, from the UDM, subscribed sensing service quality (SSQ) information.

13. The network entity of claim 8, wherein the controller is further configured to:
transmit, to the UE, a sensing service policy including at least one of information for application SSQ information, ISAC service identifier, ISAC service type, application space range, or application time range.

14. The network entity of claim 8, wherein the controller is further configured to:
perform authentication on sensing service requester through interworking with a unified data management (UDM) or a network exposure function (NEF).
